(19) United States
(12) Patent Application Publication
(10) Pub. No.: US 2011/0281539 A1
(43) Pub. Date: Nov. 17, 2011

(54) RADIO WAVE ARRIVAL ANGLE DETECTING DEVICE AND RADIO WAVE ARRIVAL ANGLE DETECTING METHOD

(75) Inventor: Hideaki Yamada, Shimosuwa-machi (JP)

(73) Assignee: Seiko Epson Corporation, Shinjuku-ku (JP)

(21) Appl. No.: 13/105,767

(22) Filed: May 11, 2011

(30) Foreign Application Priority Data
May 13, 2010 (JP) 2010-110873

(51) Int. Cl. H04B 7/00

(52) U.S. Cl. 455/269

(57) ABSTRACT

A radio wave arrival angle detecting device includes: a first receiver antenna; a second receiver antenna that is located apart from the first receiver antenna by a distance less than the wavelength of the signal wave; an oscillator that outputs an oscillation wave at the same frequency as the signal wave; a first multiplier that outputs a first mixture wave by multiplying the first signal wave by the oscillation wave; a first filter that extracts a first DC component of the first mixture wave; a second multiplier that outputs a second mixture wave by multiplying the second signal wave by the oscillation wave; a second filter that extracts a second DC component of the second mixture wave; and an arrival angle calculator that calculates a phase difference between the first signal wave and the second signal wave and that calculates an arrival angle of the signal wave.

### BACKGROUND

1. Technical Field

The present invention relates to a radio wave arrival angle detecting device and a radio wave arrival angle detecting method.

2. Related Art

A method of measuring a position of a receiver device by allowing the receiver device to receive radio waves transmitted from plural transmitter devices or measuring a position of a transmitter device by allowing plural receiver devices to receive radio waves transmitted from the transmitter device is widely carried out.

For example, JP-A-2006-71389 proposes a method of allowing a portable terminal device to receive radio waves simultaneously transmitted from plural radio base station devices and measuring a position of the portable terminal device using a time difference between the reception times.

However, in the method of measuring a position using a time difference, plural transmitter devices which are radio base station devices have to transmit radio waves at the same time. Accordingly, there is a problem in that the respective transmitter devices have to include a high-precision timer and correct time with high precision.

### SUMMARY

An advantage of some aspects of the invention is to solve at least a part of the problems described above, and the invention can be embodied as the following aspects or application examples.

### Application Example 1

According to this application example of the invention, there is provided a radio wave arrival angle detecting device including: a first receiver antenna that receives a signal wave transmitted from a transmitter device as a first signal wave; a second receiver antenna that is located apart from the first receiver antenna by a distance less than the wavelength of the signal wave and that receives the signal wave transmitted from the transmitter device as a second signal wave; an oscillator that outputs an oscillation wave at the same frequency as the signal wave; a first multiplier that outputs a first mixture wave by multiplying the first signal wave by the oscillation wave; a first filter that extracts a first DC component of the first mixture wave; a second multiplier that outputs a second mixture wave by multiplying the second signal wave by the oscillation wave; a second filter that extracts a second DC component of the second mixture wave; and an arrival angle calculator that calculates a phase difference between the first signal wave and the second signal wave from the first DC component and the second DC component and that calculates an arrival angle of the signal wave on the basis of the phase difference and the distance.

According to this configuration, the first multiplier multiplies the first signal wave by the oscillation wave of the same frequency as the first signal wave and the second multiplier multiplies the second signal wave by the oscillation wave of the same frequency as the second signal wave. Accordingly, the first mixture wave includes the first DC component and the second mixture wave includes the second DC component.

The first receiver antenna and the second receiver antenna are located apart from each other by a distance less than the wavelength of the signal wave. Accordingly, the time difference between the time point when the first signal wave is received by the first receiver antenna and the time point when the second signal wave is received by the second receiver antenna is less than one period of the signal wave. That is, the phase difference between the first signal wave and the second signal wave is less than 2π rad (360 degrees).

Accordingly, the arrival angle calculator can calculate the phase difference between the first signal wave and the second signal wave from the first DC component extracted by the first filter and the second DC component extracted by the second filter and can calculate the arrival angle of the signal wave on the basis of the calculated phase difference and the distance between the first receiver antenna and the second receiver antenna. Therefore, the arrival angle calculator can calculate the arrival angle of the signal wave transmitted from the transmitter device without a time function. As a result, the transmitter device does not have to include a high-precision timer. Accordingly, it is not necessary to correct time with high precision.

### Application Example 2

According to this application example of the invention, there is provided a radio wave arrival angle detecting method including: receiving a signal wave transmitted from a transmitter device as a first signal wave by the use of a first receiver antenna; receiving the signal wave transmitted from the transmitter device as a second signal wave by the use of a second receiver antenna located apart from the first receiver antenna by a distance less than the wavelength of the signal wave; outputting an oscillation wave at the same frequency as the signal wave; outputting a first mixture wave by multiplying the first signal wave by the oscillation wave; extracting a first DC component of the first mixture wave; outputting a second mixture wave by multiplying the second signal wave by the oscillation wave; extracting a second DC component of the second mixture wave; and calculating a phase difference between the first signal wave and the second signal wave from the first DC component and the second DC component and calculating an arrival angle of the signal wave on the basis of the phase difference and the distance.

According to this configuration, the first signal wave is multiplied by the oscillation wave of the same frequency as the first signal wave and the second signal wave is multiplied by the oscillation wave of the same frequency as the second signal wave. Accordingly, the first mixture wave includes the first DC component and the second mixture wave includes the second DC component.

The first receiver antenna and the second receiver antenna are located apart from each other by a distance less than the wavelength of the signal wave. Accordingly, the time difference between the time point when the first signal wave is received by the first receiver antenna and the time point when the second signal wave is received by the second receiver antenna is less than one period of the signal wave. That is, the phase difference between the first signal wave and the second signal wave is less than 2π rad (360 degrees).

Accordingly, the phase difference between the first signal wave and the second signal wave can be calculated from the extracted first DC component and the extracted second DC component and the arrival angle of the signal wave can be calculated on the basis of the calculated phase difference and the distance between the first receiver antenna and the second receiver antenna. Therefore, it is possible to calculate the arrival angle of the signal wave transmitted from the transmitter device without a time function. As a result, the transmitter device does not have to include a high-precision timer. Accordingly, it is not necessary to correct time with high precision.

### BRIEF DESCRIPTION OF THE DRAWINGS

The invention will be described with reference to the accompanying drawings, wherein like numbers reference like elements.

FIG. 1 is a block diagram partially illustrating the configuration of a radio wave arrival angle detecting device according to an embodiment of the invention.

FIG. 2 is a diagram illustrating the relation between a phase difference and a radio wave arrival angle.

### DESCRIPTION OF EXEMPLARY EMBODIMENTS

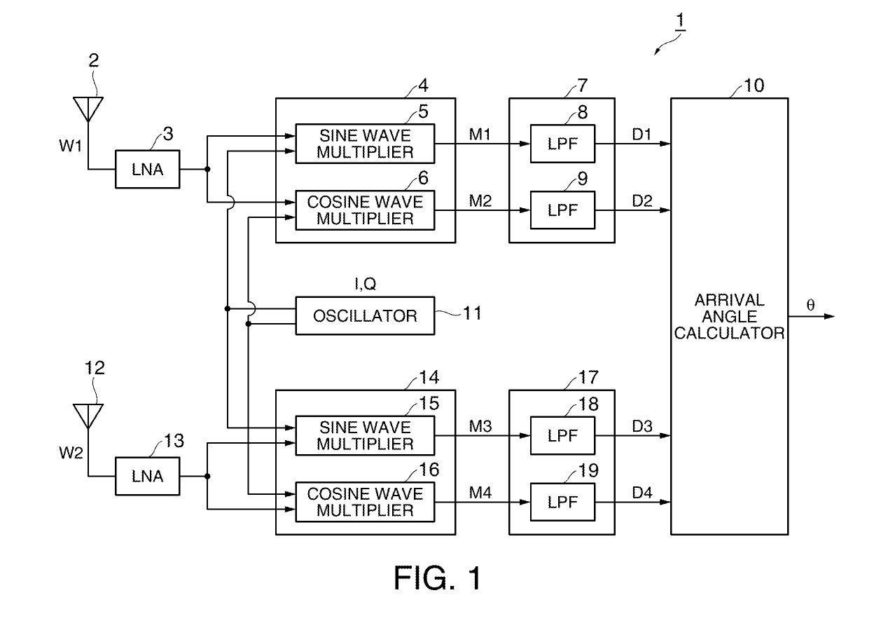

Hereinafter, exemplary embodiments of the invention will be described with reference to the accompanying drawings. FIG. 1 is a block diagram partially illustrating the configuration of a radio wave arrival angle detecting device 1 according to an embodiment of the invention. A first receiver antenna 2 receives a signal wave transmitted as a radio wave from a transmitter device (not shown) as a first signal wave W1. The first signal wave W1 received by the first receiver antenna 2 is amplified by a low noise amplifier (LNA) 3.

An oscillator 11 outputs an oscillation wave at the same frequency as the signal wave from the transmitter device. In this embodiment, the oscillator 11 oscillates a sine wave I and a cosine wave Q as the oscillation wave.

A first multiplier 4 outputs a mixture wave M1 and a mixture wave M2 as a first mixture wave by multiplying the first signal wave W1 input from the LNA 3 by the sine wave I and the cosine wave Q input from the oscillator 11. The mixture wave M1 is output by causing a sine wave multiplier 5 of the first multiplier 4 to multiply the first signal wave W1 by the sine wave I. The mixture wave M2 is output by causing a cosine wave multiplier 6 of the first multiplier 4 to multiply the first signal wave W1 by the cosine wave Q.

A first filter 7 extracts DC components D1 and D2 as a first DC component from the mixture waves M1 and M2 as the first mixture wave. The DC component D1 is extracted from the mixture wave M1 by a low-pass filter (LPF) 8 of the first filter 7. The DC component D2 is extracted from the mixture wave M2 by a low-pass filter (LPF) 9 of the first filter 7.

A second receiver antenna 12 receives a signal wave transmitted as a radio wave from the transmitter device as a second signal wave W2. The second signal wave W2 received by the second receiver antenna 12 is amplified by a low noise amplifier (LNA) 13.

A second multiplier 14 outputs a mixture wave M3 and a mixture wave M4 as a second mixture wave by multiplying the second signal wave W2 input from the LNA 13 by the sine wave I and the cosine wave Q input from the oscillator 11. The mixture wave M3 is output by causing a sine wave multiplier 15 of the second multiplier 14 to multiply the second signal wave W2 by the sine wave I. The mixture wave M4 is output by causing a cosine wave multiplier 16 of the second multiplier 14 to multiply the second signal wave W2 by the cosine wave Q.

A second filter 17 extracts DC components D3 and D4 as a second DC component from the mixture waves M3 and M4 as the second mixture wave. The DC component D3 is extracted from the mixture wave M3 by a low-pass filter (LPF) 18 of the second filter 17. The DC component D4 is extracted from the mixture wave M4 by a low-pass filter (LPF) 19 of the second filter 17.

An arrival angle calculator 10 includes an AD converter (not shown), a CPU (not shown), a RAM (not shown), and a ROM (not shown). The AD converter converts the DC components D1, D2, D3, and D4 from analog to digital. The arrival angle calculator 10 works by causing the CPU to read a program stored in the ROM into the RAM and to execute the read program.

The ROM includes a table in which values of trigonometric functions and values of inverse trigonometric functions are stored and can calculate an angle as the value of an inverse trigonometric function from the value of a trigonometric function. The arrival angle calculator 10 calculates an arrival angle of the signal wave transmitted from the transmitter device on the basis of the digital quantity acquired from the AD converter.

A method of calculating the arrival angle of the signal wave will be described below in detail.

When an angular frequency is defined as α, a time is defined as t, and a phase is defined as φ1, the first signal wave W1 is expressed as a cosine wave of Expression (1).

W1=cos(αt+φ1) (1)

The oscillator 11 oscillates a sine wave I of Expression (2) and a cosine wave Q of Expression (3), where β represents an angular frequency.

I=sin βt (2)

Q=cos βt (3)

The sine wave multiplier 5 of the first multiplier 4 multiplies the first signal wave W1 input from the LNA 3 by the sine wave I input from the oscillator 11 and outputs the mixture wave M1 of Expression (4).

$$\begin{matrix}M 1 = W 1 \times I \\ = cos ( α t + φ 1 ) \times sin β t \\ = [ sin ( ( α + β ) t + φ 1 ) and sin ( ( α - β ) t + φ 1 ) ] / 2\end{matrix} \qquad ( 4 )$$

The LPF 8 blocks a high frequency component of the mixture wave M1 and passes only a low frequency component. Accordingly, the mixture wave M1 is expressed by Expression (5).

M1=[sin((α−β)t+φ1)]/2 (5)

Since the frequency of the sine wave I oscillated by the oscillator 11 is the same as the frequency of the first signal wave W1, the angular frequency β of the sine wave I is the same as the angular frequency α of the first signal wave W1. Accordingly, the LPF 8 extracts the DC component D1 of Expression (6) included in the mixture wave M1.

D1=[sin φ1]/2 (6)

The cosine wave multiplier 6 of the first multiplier 4 multiplies the first signal wave W1 input from the LNA 3 by the cosine wave Q input from the oscillator 11 and outputs the mixture wave M2 of Expression (7).

$$\begin{matrix}M 2 = W 1 \times Q \\ = cos ( α t + φ 1 ) \times cos β t \\ = [ cos ( ( α + β ) t + φ 1 ) + cos ( ( α - β ) t + φ 1 ) ] / 2\end{matrix} \qquad ( 7 )$$

The LPF 9 blocks a high frequency component of the mixture wave M2 and passes only a low frequency component. Accordingly, the mixture wave M2 is expressed by Expression (8).

M2=[cos((α−β)t+φ1)]/2 (8)

The angular frequency β of the cosine wave Q is the same as the angular frequency α of the first signal wave W1. Accordingly, the LPF 9 extracts the DC component D2 of Expression (9) included in the mixture wave M2.

D2=[cos φ1]/2 (9)

When an angular frequency is defined as α, a time is defined as t, and a phase is defined as φ2, the second signal wave W2 is expressed as a cosine wave of Expression (10).

W2=cos(αt+φ2) (10)

The sine wave multiplier 15 of the second multiplier 14 multiplies the second signal wave W2 input from the LNA 13 by the sine wave I input from the oscillator 11 and outputs the mixture wave M3 of Expression (11).

$$\begin{matrix}M 3 = W 2 \times I \\ = cos ( α t + φ 2 ) \times sin β t \\ = [ sin ( ( α + β ) t + φ 2 ) + sin ( ( α - β ) t + φ 2 ) ] / 2\end{matrix} \qquad ( 11 )$$

The LPF 18 blocks a high frequency component of the mixture wave M3 and passes only a low frequency component. Accordingly, the mixture wave M3 is expressed by Expression (12).

M3=[sin((α−β)t+φ2)]/2 (12)

Since the frequency of the sine wave I oscillated by the oscillator 11 is the same as the frequency of the second signal wave W2, the angular frequency β of the sine wave I is the same as the angular frequency α of the second signal wave W2. Accordingly, the LPF 18 extracts the DC component D3 of Expression (13) included in the mixture wave M3.

D3=[sin φ2]/2 (13)

The cosine wave multiplier 16 of the second multiplier 14 multiplies the second signal wave W2 input from the LNA 13 by the cosine wave Q input from the oscillator 11 and outputs the mixture wave M4 of Expression (14).

$$\begin{matrix}M 4 = W 2 \times Q \\ = cos ( α t + φ 2 ) \times cos β t \\ = [ cos ( ( α + β ) t + φ 2 ) + cos ( ( α - β ) t + φ 2 ) ] / 2\end{matrix} \qquad ( 14 )$$

The LPF 19 blocks a high frequency component of the mixture wave M4 and passes only a low frequency component. Accordingly, the mixture wave M4 is expressed by Expression (15).

M4=[cos((α−β)t+φ2)]/2 (15)

The angular frequency β of the cosine wave Q is the same as the angular frequency α of the second signal wave W2. Accordingly, the LPF 19 extracts the DC component D4 of Expression (16) included in the mixture wave M4.

D4=[cos φ2]/2 (16)

The arrival angle calculator 10 converts the DC component D1 of Expression (6) and the DC component D2 of Expression (9) from analog to digital and calculates a tangent value of Expression (17).

$$\begin{matrix}tan φ 1 = sin φ 1 / cos φ 1 \\ = D 1 / D 2\end{matrix} \qquad ( 17 )$$

The arrival angle calculator 10 converts the DC component D3 of Expression (13) and the DC component D4 of Expression (16) from analog to digital and calculates a tangent value of Expression (18).

$$\begin{matrix}tan φ 2 = sin φ 2 / cos φ 2 \\ = D 3 / D 4\end{matrix} \qquad ( 18 )$$

The arrival angle calculator 10 calculates the phase φ1 of the first signal wave W1 which is an inverse trigonometric function of the tangent value expressed by Expression (17) and the phase φ2 of the second signal wave W2 which is an inverse trigonometric function of the tangent value expressed by Expression (18) and calculates a phase difference Δλ which is a difference between the phase φ1 and the phase φ2 as expressed by Expression (19).

$$\begin{matrix}Δ λ = φ 1 - φ 2 \\ = {tan}^{- 1} φ 1 - {tan}^{- 1} φ 2\end{matrix} \qquad ( 19 )$$

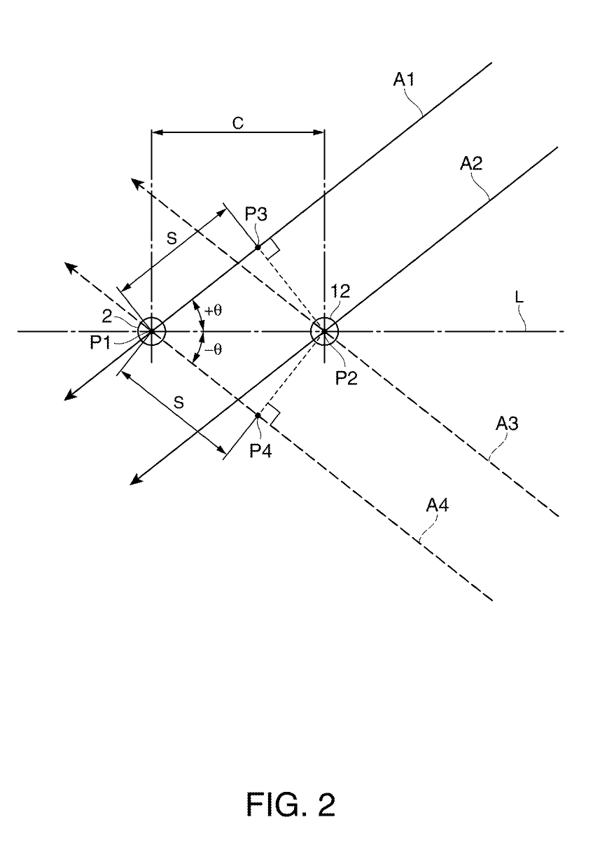

FIG. 2 is a diagram illustrating the relation between the phase difference Δλ and the radio wave arrival angle. The signal waves received by the first receiver antenna 2 and the second receiver antenna 12 are signal waves A1 and A2 of which the radio wave arrival angle about a straight line L connecting the first receiver antenna 2 and the second receiver antenna 12 is +θ or signal waves A3 and A4 of which the radio wave arrival angle about the straight line L is −θ. An example where the signal waves A1 and A2 are received by the first receiver antenna 2 and the second receiver antenna 12 will be described below.

An intersection of a perpendicular line directed from the position P2 of the second receiver antenna 12 with the signal wave A1 is defined as a position P3. When the signal waves A1 and A2 are transmitted from a transmitter device at the same time, the time point when the signal wave A1 arrives at the position P3 is equal to the time point when the signal wave A2 arrives at the position P2 and is received by the second receiver antenna 12.

When the signal wave A1 travels through the distance S from the position P3 to the position P1 of the first receiver antenna 2 and arrives at the position P1, the signal wave A1 is received by the first receiver antenna 2. Accordingly, since a time difference exists between the time point when the signal wave A1 is received by the first receiver antenna 2 and the time point when the signal wave A2 is received by the second receiver antenna 12, a phase difference Δλ exists between the phase φ1 of the first signal wave W1 received by the first receiver antenna 2 and the phase φ2 of the second signal wave W2 received by the second receiver antenna 12.

The position P1 of the first receiver antenna 2 and the position P2 of the second receiver antenna 12 are separated apart from each other by a distance C less than the wavelength of the signal waves A1 and A2. Accordingly, the time difference between the time point when the first signal wave W1 is received by the first receiver antenna 2 and the time point when the second signal wave W2 is received by the second receiver antenna 12 is less than one period. That is, the value of the phase difference Δλ can be set to be less than 2π rad (360 degrees).

When the speed of the signal wave A1 is defined as V and the time by which the signal wave A1 travels from the position P3 to the position P1 is defined as Δt, the distance S is expressed by Expression (20).

S=VΔt (20)

Since the time Δt is expressed by Δt=Δλ/2π·1/f where f represents the frequency of the signal wave A1, the distance S is expressed by Expression (21).

S=V(Δλ/2π·1/f) (21)

Here, when V/2π·1/f is defined as a constant K, the distance S is expressed by Expression (22).

S=KΔλ (22)

On the other hand, the distance S in FIG. 2 is expressed by Expression (23) using the distance C and the radio wave arrival angle θ.

S=C·cos θ (23)

Accordingly, since KΔλ=C·cos θ, the cosine value expressed by Expression (24) is calculated.

cos θ=KΔλ/C (24)

The radio wave arrival angle θ of the signal waves A1 and A2 is the value of an inverse trigonometric function of the cosine value and thus is calculated by Expression (25).

θ=cos⁻¹(KΔλ/C) (25)

The arrival angle calculator 10 calculates the radio wave arrival angle θ of the signal waves A1 and A2 on the basis of the constant K, the phase difference Δλ calculated by Expression (19), and the distance C shown in FIG. 2 as expressed by Expression (25).

The same is true of the case where signal waves A3 and A4 are received by the first receiver antenna 2 and the second receiver antenna 12. An intersection of a perpendicular line directed from the position P2 of the second receiver antenna 12 with the signal wave A4 is defined as a position P4. The time points when the signal waves A3 and A4 simultaneously transmitted from the transmitter device arrive at the positions P2 and P4, respectively, are the same as each other. The signal wave A4 further travels through the distance S from the position P4 to the position P1 and arrives at the first receiver antenna 2. Accordingly, the phase difference Δλ exists between the phase φ1 of the first signal wave W1 received by the first receiver antenna 2 and the phase φ2 of the second signal wave W2 received by the second receiver antenna 12. By using the above-mentioned method, the radio wave arrival angle detecting device 1 can detect the radio wave arrival angle −θ.

Accordingly, it is possible to detect the radio wave arrival angle of a signal wave by the use of plural radio wave arrival angle detecting devices 1 of which coordinate positions are recognized in advance and to measure the position of the transmitter device transmitting the signal wave by the use of a triangulation method. Alternatively, it is possible to detect the arrival angle of a signal wave transmitted from plural transmitter devices of which coordinate positions are recognized in advance and to measure a position of the radio wave arrival angle detecting device 1 by the use of the triangulation method.

The radio wave arrival angle detecting device 1 described in this embodiment includes the first receiver antenna 2 that receives a signal wave transmitted from a transmitter device as a first signal wave W1, the second receiver antenna 12 that is located apart from the first receiver antenna 2 by a distance C less than the wavelength of the signal wave and that receives the signal wave transmitted from the transmitter device as a second signal wave W2, the oscillator 11 that outputs a sine wave I and a cosine wave Q as an oscillation wave at the same frequency as the signal wave, the first multiplier 4 that outputs mixture waves M1 and M2 as a first mixture wave by multiplying the first signal wave W1 by the oscillation wave, the first filter 7 that extracts DC components D1 and D2 as a first DC component of the first mixture wave, the second multiplier 14 that outputs mixture waves M3 and M4 as a second mixture wave by multiplying the second signal wave W2 by the oscillation wave, the second filter 17 that extracts DC components D3 and D4 as a second DC component of the second mixture wave, and the arrival angle calculator 10 that calculates a phase difference Δλ between the first signal wave W1 and the second signal wave W2 from the first DC component and the second DC component and that calculates an arrival angle of the signal wave on the basis of the phase difference Δλ and the distance C.

According to this configuration, the first multiplier 4 multiplies the first signal wave W1 by the oscillation wave of the same frequency as the first signal wave W1 and the second multiplier 14 multiplies the second signal wave W2 by the oscillation wave of the same frequency as the second signal wave W2. Accordingly, the mixture waves M1 and M2 as the first mixture wave include the DC components D1 and D2 as the first DC component and the mixture waves M3 and M4 as the second mixture wave include the DC components D3 and D4 as the second DC component.

The first receiver antenna 2 and the second receiver antenna 12 are located apart from each other by the distance C less than the wavelength of the signal wave. Accordingly, the time difference between the time point when the first signal wave W1 is received by the first receiver antenna 2 and the time point when the second signal wave W2 is received by the second receiver antenna 12 is less than one period of the signal wave. That is, the phase difference Δλ between the first signal wave W1 and the second signal wave W2 is less than 2π rad (360 degrees).

The arrival angle calculator 10 can calculate the phase difference Δλ between the first signal wave W1 and the second signal wave W2 from the DC components D1 and D2 extracted by the first filter 7 and the DC components D3 and D4 extracted by the second filter 17 and can calculate the radio wave arrival angle θ of the signal wave on the basis of the calculated phase difference Δλ and the distance C between the first receiver antenna 2 and the second receiver antenna 12. Therefore, the arrival angle calculator 10 can calculate the radio wave arrival angle θ of the signal wave transmitted from the transmitter device without a time function. As a result, the transmitter device does not have to include a high-precision timer. Accordingly, it is not necessary to correct time with high precision.

The radio wave arrival angle detecting method described in this embodiment includes a first reception step of receiving a signal wave transmitted from a transmitter device as a first signal wave W1 by the use of the first receiver antenna 2, a second reception step of receiving the signal wave transmitted from the transmitter device as a second signal wave W2 by the use of the second receiver antenna 12 located apart from the first receiver antenna 2 by a distance C less than the wavelength of the signal wave, an oscillation step of outputting a sine wave I and a cosine wave Q as an oscillation wave at the same frequency as the signal wave, a first multiplication step of outputting mixture waves M1 and M2 as a first mixture wave by multiplying the first signal wave W1 by the oscillation wave, a first DC component extracting step of extracting DC components D1 and D2 as a first DC component of the first mixture wave, a second multiplication step of outputting mixture waves M3 and M4 as a second mixture wave by multiplying the second signal wave W2 by the oscillation wave, a second DC component extracting step of extracting DC components D3 and D4 as a second DC component of the second mixture wave, and an arrival angle calculating step of calculating a phase difference Δλ between the first signal wave W1 and the second signal wave W2 from the DC components D1, D2, D3, and D4 and calculating an arrival angle of the signal wave on the basis of the phase difference Δλ and the distance C.

According to this configuration, the first signal wave W1 is multiplied by the oscillation wave of the same frequency as the first signal wave W1 in the first multiplication step and the second signal wave W2 is multiplied by the oscillation wave of the same frequency as the second signal wave W2 in the second multiplication step. Accordingly, the mixture waves M1 and M2 as the first mixture wave include the DC components D1 and D2 as the first DC component and the mixture waves M3 and M4 as the second mixture wave include the DC components D3 and D4 as the second DC component.

The first receiver antenna 2 used in the first reception step and the second receiver antenna 12 used in the second reception step are located apart from each other by the distance C less than the wavelength of the signal wave. Accordingly, the time difference between the time point when the first signal wave W1 is received by the first receiver antenna 2 and the time point when the second signal wave W2 is received by the second receiver antenna 12 is less than one period of the signal wave. That is, the phase difference Δλ between the first signal wave W1 and the second signal wave W2 is less than 2π rad (360 degrees).

In the arrival angle calculating step, the phase difference Δλ between the first signal wave W1 and the second signal wave W2 is calculated from the DC components D1 and D2 extracted by the first filter 7 and the DC components D3 and D4 extracted by the second filter 17 and the radio wave arrival angle θ of the signal wave is calculated on the basis of the calculated phase difference Δλ and the distance C between the first receiver antenna 2 and the second receiver antenna 12. Therefore, in the arrival angle calculating step, it is possible to calculate the radio wave arrival angle θ of the signal wave transmitted from the transmitter device without a time function. As a result, the transmitter device does not have to include a high-precision timer. Accordingly, it is not necessary to correct time with high precision.

The entire disclosure of Japanese Patent Application No. 2010-110873, filed May 13, 2010 is expressly incorporated by reference herein.

What is claimed is:

1. A radio wave arrival angle detecting device comprising:
a first receiver antenna that receives a signal wave transmitted from a transmitter device as a first signal wave;
a second receiver antenna that is located apart from the first receiver antenna by a distance less than the wavelength of the signal wave and that receives the signal wave transmitted from the transmitter device as a second signal wave;
an oscillator that outputs an oscillation wave at the same frequency as the signal wave;
a first multiplier that outputs a first mixture wave by multiplying the first signal wave by the oscillation wave;
a first filter that extracts a first DC component of the first mixture wave;
a second multiplier that outputs a second mixture wave by multiplying the second signal wave by the oscillation wave;
a second filter that extracts a second DC component of the second mixture wave; and
an arrival angle calculator that calculates a phase difference between the first signal wave and the second signal wave from the first DC component and the second DC component and that calculates an arrival angle of the signal wave on the basis of the phase difference and the distance.

2. A radio wave arrival angle detecting method comprising:
receiving a signal wave transmitted from a transmitter device as a first signal wave by the use of a first receiver antenna;
receiving the signal wave transmitted from the transmitter device as a second signal wave by the use of a second receiver antenna located apart from the first receiver antenna by a distance less than the wavelength of the signal wave;
outputting an oscillation wave at the same frequency as the signal wave;
outputting a first mixture wave by multiplying the first signal wave by the oscillation wave;
extracting a first DC component of the first mixture wave;
outputting a second mixture wave by multiplying the second signal wave by the oscillation wave;
extracting a second DC component of the second mixture wave; and
calculating a phase difference between the first signal wave and the second signal wave from the first DC component and the second DC component and calculating an arrival angle of the signal wave on the basis of the phase difference and the distance.
